(19) United States
(12) Patent Application Publication
(10) Pub. No.: US 2007/0165702 A1
(43) Pub. Date: Jul. 19, 2007

(54) Apparatus for measuring frequency error of CDMA signals

(76) Inventor: Mitsuru Yokoyama, Hyogo (JP)

Correspondence Address: Paul D. Greeley;Ohlandt, Greeley, Ruggiero & Perle, L.L.P., 10th Floor, One Landmark Square, Stamford, CT, 06901-2682, US

(21) Appl. No.: 11/603,391

(22) Filed: Nov. 22, 2006

(30) Foreign Application Priority Data
Jan. 16, 2006 (JP) 2006-007766

(51) Int. Cl. H04B 1/00; H04K 1/10

(52) U.S. Cl. 375/147; 375/260

(57) ABSTRACT

Phase error signals are detected at the symbol evaluation point of signals under test that have been receiver filter-processed, and reference signals obtained by remodulation and respreading of bit data restored from the filter-processed signals under test, or signals obtained by differentiating said phase error signals are calculated, and either of these are displayed as a graph over the period of time when they have a length exceeding one slot.

### FIELD OF THE INVENTION

The present disclosure relates to an apparatus for measuring the phase error or frequency error of CDMA digital modulation signals.

### DISCUSSION OF THE BACKGROUND ART

CDMA systems are now used for mobile communications. Moreover, there are diverse types of standards that stipulate the specifications of the digital modulation signals, etc, in CDMA systems. Examples of these standards are 3GPP FDD, ARIB STD-T63, and ARIB TR-T12. Section 6.7.1.1 of Standard TS25.141 and Section 5.13.1.1 of Standard TS34.121 stipulate that the EVM, phase error which is phase difference, and average frequency deviation(average frequency error) of the CDMA signals are measured for each slot. The reason for measuring by slot units is because CDMA systems stipulated by the above-mentioned Standards transmit and receive data in slot units. For instance, W-CDMA signals have embedded pilot signals for acquiring synchronization with each slot in order to improve the sensitivity of synchronization. These pilot signals help to improve the sensitivity of synchronization in an environment in which fading, and similar phenomena occur. It is assumed that a synchronization correction, a frequency correction, etc. can be conducted for each slot; therefore, the above-mentioned standards require that each slot be measured. The operators, device manufacturers, test system manufacturers, and test conductors (inspectors), etc. design and test the device in accordance with the above-mentioned standards (for instance, refer to JP Unexamined Patent Application (Kokai) 2000-324182 (pages 3 through 9, FIG. 6) and JP Unexamined Patent Application (Kokai) 9-307525 (pages 4 and 5, FIG. 1)).

The above-mentioned standards stipulate means for comformance test. Consequently, even if a communications device is tested in accordance with method stipulated by the above-mentioned standards and the results are good, they do not completely guarantee the stability of communications by the communications device in question. Actually, there are cases wherein there are problems with communications between communications devices themselves that have passed the tests stipulated by the specifications. For instance, there are cases in which problems develop with communications quality, such as a high bit error rate, and similar problems, even though there have been no problems with the EVM, average frequency error, or phase error of each slot. Thus, it is not possible to identify problems with CDMA signals and communications devices by conventional measurement methods alone and there is a need for new measurement methods and measuring apparatuses based on these methods.

The present disclosure provides measurement technology that is different from the conventional measurement of the average frequency error of slot units in that it focuses on cases in which fluctuations in the frequency wherein the period is the same as the slot interval or is longer than the slot interval, or extreme transition of frequency within a slot, lead to communications problems. That is, the present disclosure provides a measurement method for continuously measuring frequency fluctuations within a slot regardless of the slot boundary, and a measuring apparatus that uses this method, in order to test or analyze the signals of a CDMA system that transmits and receives data in slot units, including the pilot signals for each slot, or the signals of a CDMA system that transmits and receives data in slot units using common pilot signals. It also provides a method for continuously measuring phase fluctuations within a slot regardless of the slot boundary and a measuring apparatus that uses this method.

### SUMMARY OF THE INVENTION

The first subject of the invention is an apparatus for measuring the frequency error of digital modulation signals from a CDMA system whereby data are transmitted and received in slot units, including the pilot signals for each slot, or a CDMA system whereby data are transmitted and received in slot units using common pilot signals, this apparatus for measuring the frequency error being characterized in that it comprises a reference signal generator to calculate a reference signal according to bit data obtained by de-spreading and demodulation of the measured digital modulation signals using the modulation parameters and spreading parameters that are used when the digital modulation signals are generated; a comparator for comparing the measured digital modulation signals and the reference signals and generating phase error signals that represent the phase error at each symbol evaluation point of the measured digital modulation signals with respect to the reference signals; and a differentiator for calculating the gradient of the phase error signals for each of multiple intervals shorter than the slot length of the measured digital modulation signals, and each of the multiple intervals is lined up in a time series adjacent to one another or partially overlapping one another and the overall length is longer than one slot.

The second subject of the invention is the apparatus of the first subject of the invention, further characterized in having a display device for displaying a graph of the calculation results of the differentiator lined up in a time series.

The third subject of the invention is the apparatus of the second subject of the invention, further characterized in that the display device displays a graph of the modulation accuracy (error vector magnitude at each chip point) of the measured digital modulation signals such that its time position coincides with the graph of the calculation results.

The fourth subject of the invention is the apparatus of the second or third subject of the invention, further characterized in that the display device displays a graph of the phase error signals such that its time position coincides with the graph of these calculation results.

The fifth subject of the invention is an apparatus for measuring the phase error of digital modulation signals from a CDMA system whereby data are transmitted and received in slot units, including the pilot signals for each slot, or a CDMA system whereby data are transmitted and received in slot units using common pilot signals, this apparatus for measuring the phase error being characterized in that it comprises a reference signal generator for generating reference signals with remodulating and respreading bit data obtained by de-spreading and demodulation of the measured digital modulation signals using the modulation parameters and spreading parameters that are used when the digital modulation signals are generated, and outputting the resulting signals as reference signals, and a comparator for comparing the measured digital modulation signals and the reference signals and generating phase error signals that represent the phase error at each symbol evaluation point of the measured digital modulation signals with respect to the reference signals.

The sixth subject of the invention is the apparatus according to the fifth subject of the invention, further characterized in that it also comprises an indicator for displaying a graph of the phase error signals.

The seventh subject of the invention is the apparatus according to the sixth subject of the invention, further characterized in that the graph of the phase error signals is continuous at the front and back of the boundary of each slot.

The eighth subject of the invention is the apparatus according to the sixth or seventh subject of the invention, further characterized in that the display device displays a graph of the modulation accuracy (error vector magnitude at each chip point) of the measured digital modulation signals such that its time position coincides with the graph of the phase error signals.

The present disclosure further includes a method for measuring the frequency error of digital modulation signals from a CDMA system whereby data are transmitted and received in slot units, including the pilot signals for each slot, or a CDMA system whereby data are transmitted and received in slot units using common pilot signals, the method comprising:

remodulating and respreading of bit data obtained by de-spreading and demodulation of the digital modulation signals using the modulation parameters and spreading parameters that are used when the digital modulation signals are generated, and outputting the resulting signals as reference signals;

comparing the digital modulation signals and the reference signals and generating phase error signals that represent the phase error at each symbol evaluation point of the digital modulation signals with respect to the reference signals; and

calculating the gradient of the phase error signals for each of multiple intervals shorter than the slot length of the digital modulation signals,

outputting the calculation results,

wherein each of the multiple intervals are lined up in a time series adjacent to one another or partially overlapping one another and the overall length is longer than one slot.

The method further comprising displaying a graph of the calculation results lined up in a time series.

The method further comprising displaying a graph of the modulation accuracy of the digital modulation signals such that its time position coincides with the graph of the calculation results.

The method further comprising displaying a graph of the phase error signals such that its time position coincides with the graph of the calculation results.

Another embodiment of the present disclosure involves a method for measuring the phase error of digital modulation signals from a CDMA system whereby data are transmitted and received in slot units, including the pilot signals for each slot, or a CDMA system whereby data are transmitted and received in slot units using common pilot signals, the method comprising:

remodulating and respreading of bit data obtained by de-spreading and demodulation of the digital modulation signals using the modulation parameters and spreading parameters that are used when the digital modulation signals are generated, and outputting the resulting signals as reference signals; and

comparing the digital modulation signals and the reference signals and generating phase error signals that represent the phase error at each symbol evaluation point of the digital modulation signals with respect to the reference signals;

thereby measuring the phase error of the digital modulation signals.

The method further comprising displaying a graph of the phase error signals.

Preferably, the graph of the phase error signals is continuous at the front and back of the boundary of each slot.

The method further comprising displaying a graph of the phase error signals such that the time position coincides with the graph of the calculation results.

The phrase “phase error” of the present disclosure is different from the phase error to be measured pursuant to each of the above-mentioned Standards. The “phase error” in the Standards means the residual error in the phase component, which is not expressed by the average frequency error.

By means of the present disclosure, the phase error or the frequency error of the digital modulation signals of each of multiple intervals shorter than the slot length of the digital modulation signals of the CDMA system are continuously displayed without being restricted by the slot boundary; therefore, it is possible to recognize fluctuations in frequency having the same period as the slot interval or a longer frequency than the slot interval. Moreover, places of frequency transition within slot intervals can be recognized. The displayed phase error and frequency error are processed independent of amplitude error; therefore, there is no effect from unintentional gain control such as clipping or from variable amplitude error.

Moreover, by means of the present disclosure, the phase error or frequency error is displayed with the modulation accuracy (error vector magnitude at each chip point) such that their time positions are all aligned; therefore, the phase error or frequency error and modulation error can correspond for each chip, and as a result, a large frequency displacement in a code is easily discovered as a BER degradation factor.

### BRIEF DESCRIPTION OF THE DRAWINGS

FIG. 1 is a drawing showing the structure of measuring apparatus 10, which is the first embodiment of the present disclosure.

FIG. 2 is a drawing showing the functional elements of computer 400 and the virtual correlation between each of the elements themselves.

FIG. 3 is a drawing showing the structure of reference signal generator 450.

FIG. 4 is a drawing showing the structure of reference signal generator 650.

FIG. 5 is a drawing showing an example of the screen displaying a graph of the EVM, phase error, and frequency error of signals under test S by the present disclosure.

FIG. 6 is a drawing showing an example of the screen displaying a graph of the EVM, and frequency error of signals under test S by the prior art.

### DETAILED DESCRIPTION OF THE PREFERRED EMBODIMENT

Embodiments of the present disclosure will now be described while referring to the attached drawings. The first embodiment of the present disclosure is a measuring apparatus 10. Measuring apparatus 10 is the apparatus for measuring the frequency error (frequency drift) of CDMA-type digital modulation signals. The CDMA system that is the target of measurement by measuring apparatus 10 is a CDMA system that transmits and receives data in slot units, including pilot signals for each slot, or a CDMA system that transmits and receives data in slot units using common pilot signals. Examples of this type of CDMA system are 3GPP W-CDMA (FDD), 3GPP W-CDMA (TDD), TDS-CDMA, 3GPP2 cdma2000, and 3GPP2 1x EV-DO. It should be noted that the slots holding the channel data of the above-mentioned CDMA systems that are the targets of the present disclosure are multiplexed and transmitted. In specific terms, a frame made of multiple slots is mapped into a channelization code, multiple channelization codes are combined together, and it is spread and transmitted using scramble code for base station or scramble code for mobile station.

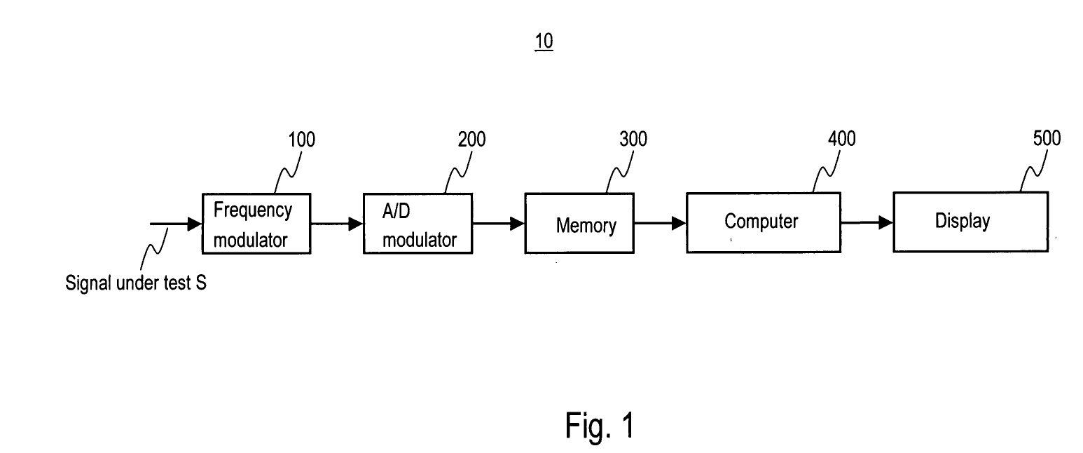

In order to simplify the description, measuring apparatus 10 is an apparatus for measuring W-CDMA downlink signals. In downlink signal, W-CDMA base station decomposes multiple channel data into bit stream in a specific length, holds each bit stream to allocated slots , maps frames composed of multiple slots into a channelization code, and further bundles multiple channelization codes and spreads data by a scrambling code and transmits the spreading result. In a W-CDMA downlinking, it is allowed to shift the transmission time for data contained in each channelization code, but the interval of the measurement, such as EVM, is defined by the slot of the common pilot (CPICH). Refer to FIG. 1. FIG. 1 is a drawing of the structure of measuring apparatus 10. The structure and operation of measuring apparatus 10 will now be described. Measuring apparatus 10 comprises a frequency converter 100, an analog-digital converter 200, a memory 300, a computer 400, and a display 500.

Frequency converter 100 is a down converter. Frequency converter 100 down converts the received signals under test S and outputs the down converted results. Signals under test S are W-CDMA downlink signals. Analog-digital converter 200 is a device for converting analog signals to digital signals. Analog-digital converter 200 digitally converts signals under test S that have been down converted by frequency converter 100 and outputs the conversion results. Analog-digital converter 200 is called A/D converter 200 below. Memory 300 is a storage unit. Memory 300 houses the digital data that are output by A/D converter 200. There are no particular restrictions to the type of medium used for memory 300 as long as it is capable of housing the incoming data with no leakage and of outputting data as needed without delay; therefore, it can be a semiconductor memory, a hard disk drive, and similar components.

Computer 400 is a device that conducts predetermined mathematical operations and predetermined controls by execution of a program. Computer 400 processes the down-converted and digitally converted signals under test S, which are the data stored in memory 300. The down-converted and digitally converted signals under test S are called base band signals B under test. The program executed by computer 400 is stored in, for instance, a memory medium (not illustrated) fixed inside computer 400, a memory medium (not illustrated) that can be removed from computer 400, or an external memory medium (not illustrated) that is joined to computer 400 by wired connection or wireless connection. Examples of these memory media are hard disk drives and semiconductor memories inside computer 400, semiconductor memory devices, CDROMs, and floppy disks that can be removed from computer 400, and hard disk drives and servers for downloading that are connected to computer 400 by a transmission medium such as a USB port or network. It should be noted that computer 400 can be a processor such as an MPU or DSP, a gate array comprising a core such as these processors, or a board or computer system comprising these processors or gate arrays. Display 500 is a display device. Display 500 is controlled by computer 400 and displays graphs, videos, characters, and similar data.

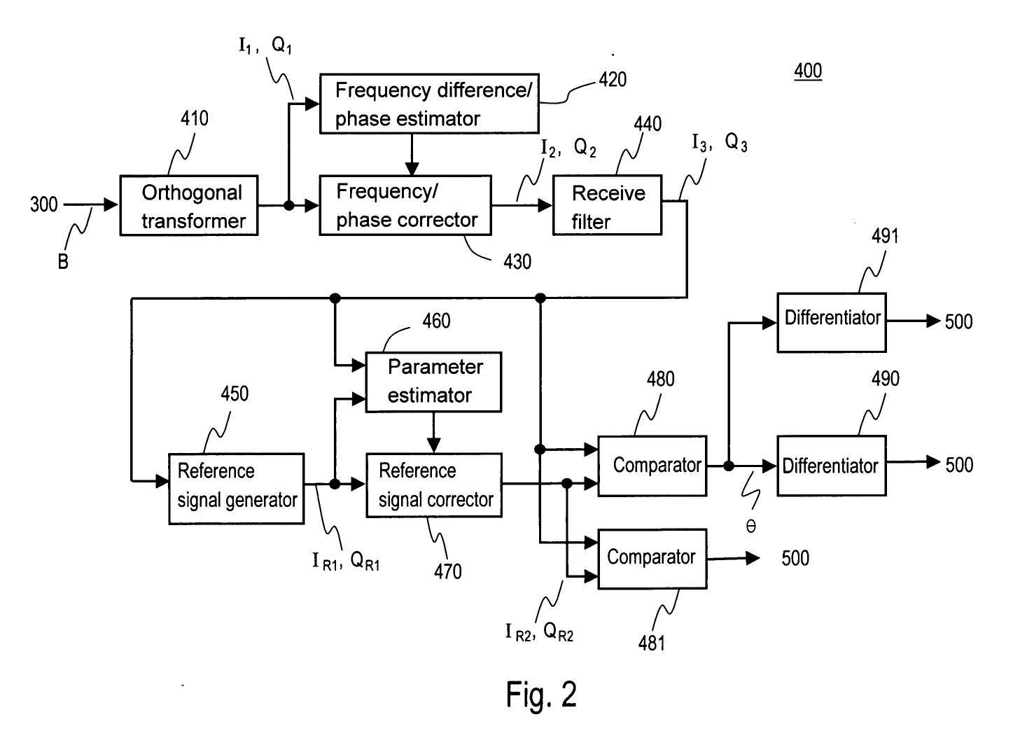

Computer 400 executes programs to function as an orthogonal transformer 410, a frequency difference/phase estimator 420, a frequency-phase corrector 430, a receiver filter 440, a reference signal generator 450, a parameter estimator 460, a reference signal corrector 470, a comparator 480, and a differentiator 490. FIG. 2 is a drawing representing the functional elements of computer 400 and the relationship between the functional elements. Refer to FIG. 2.

Orthogonal transformer 410 is a device decomposing base band signals under test B and outputting complex base band signals I₁ and complex base band signals Q₁. It should be noted that regardless of the subscript, I represents an in-phase component and Q represents a quadarature component. Frequency difference/phase estimator 420 is a device for estimating the frequency error and initial phase of a carrier. Specifically, the correlation between base band signals under test B and reference signals (pilot signals) is calculated, the phase difference between these signals is found, and an estimate of the initial phase is obtained. Moreover, the phase difference, that is phase error, is found for all chip data sequence or multiple partial chip data sequence within an interval longer than one slot, a linear approximation is performed on all of the resulting phase differences, the gradient of the phase difference is found, and this gradient gives as the estimate of the overall frequency error. Frequency/phase corrector 430 corrects in-phase base band signals I₁ and quadarature base band signals Q₁ as represented by the following formula using frequency error ω₁ and initial phase θ₁. The correction results are output as in-phase base band signals I₂ and quadrature base band signals Q₂.

[Mathematical formula 1]

I₂+jQ₂=(I₁+jQ₁)e^{-jω}^{₁}^{t+θ}^{₁} (1)

Receiver filter 440 is a root Nyquist filter stipulated by 3GPP standards. In-phase base band signals I₂ and quadrature base band signals Q₂ are filtered by receiver filter 440 and output as in-phase base band signals I₃ and quadrature base band signals Q₃.

Reference signal generator 450 is the device for generating complex reference signals. Reference signal generator 450 performs de-spreading and demodulation of in-phase base band signals I₃ and quadrature base band signals Q₃ and then performs remodulation and respreading of the bit data obtained as the result thereof. The digital modulation signals obtained as a result of remodulation and respreading are output as reference in-phase signals I_{R1} and quadrature reference signals Q_{R1}. It should be noted that the parameters used for the remodulation and respreading are the same parameters as those used for the generation of signals under test S. These parameters are specifically the f, t, φ, etc. cited in Annex B of Standard TS34.121.

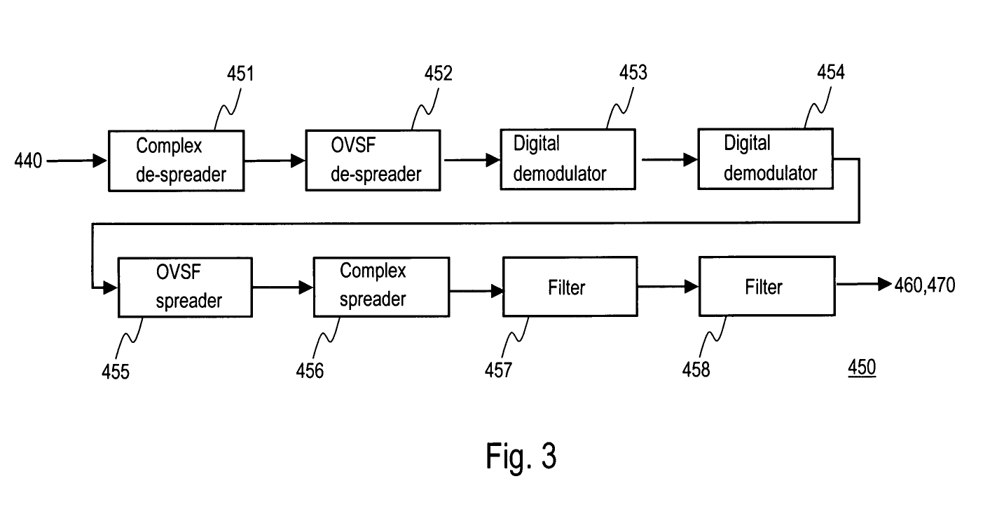

Reference signal generator 450 generates the reference signals necessary for measuring the frequency error of the downlink signals. Refer to FIG. 3. FIG. 3 is a drawing showing the internal structure of reference signal generator 450. Reference signal generator 450 comprises a complex de-spreader 451, an OVSF de-spreader 452, a digital demodulator 453, a digital modulator 454, an OVSF spreader 455, a complex spreader 456, a filter 457, and a filter 458. In-phase base band signal I₃ and quadarature base band signal Q₃ are subjected to de-spreading by complex de-spreader 451, then the active channels are submitted to de-spreading by OVSF de-spreader 452, and the resulting channels are further subjected to QPSK demodulation or 16 QAM demodulation by digital demodulator 453. These bit data are remodulated and respread using the modulation parameters and spreading parameters employed when signals under test S are replicated. That is, the replicated bit data are subjected to QPSK modulation or 16 QAM modulation by digital modulator 454, followed by spreading by OVSF spreader 455, and further, spreading by complex spreader 456. The results of complex spreading are filtered by filter 457 and filter 458 and the processing results are output as in-phase reference signal I_{R1} and quadarature reference signal Q_{R1}. It should be noted here that filters 457 and 458 are root Nyquist filters stipulated in 3GPP standards.

Refer to FIG. 2 once again. Parameter estimator 460 is the device for estimating parameters referring to in-phase base band signal I₃, quadarature base band signal Q₃, in-phase reference signal I_{R1} and quadarature reference signal Q_{R1}. The estimated parameters are the frequency, timing, phase, gain, and the like cited in Annex B Standard TS34.121. These parameters are estimated by the MMSE (minimum mean squared error) stipulated in Annex B of Standard TS34.121 (B 2.6 in version 6.2.0). Reference signal corrector 470 corrects in-phase base band signal I_{R1} and quadarature base band signal Q_{R1} based on Annex B of Standard TS34.121 using parameters estimated by parameter estimator 460. The correction results are output as in-phase reference signal I_{R2} and quadarature reference signal Q_{R2}.

Comparator 480 is the device for comparing the vector presented by in-phase base band signal I₃ and quadarature base band signal Q₃ and the reference vector represented by in-phase reference signal I_{R2} and quadarature reference signal Q_{R2} and detecting the phase difference at the symbol evaluation points between these vectors. The detected phase difference is output as phase error signal θ.

A comparator 481 compares the vector represented by in-phase base band signals I₃ and quadarature base band signals Q₃ and the reference vector represented by in-phase reference signal I_{R2} and quadarature reference signal Q_{R2} and detects the magnitude difference at the symbol evaluation points between these vectors. The detected magnitude difference is represented by the ratio to the reference vector and is output as the error vector magnitude (EVM). This EVM is also called the modulation accuracy. It should be noted that the modulation accuracy stipulated by 3GPP standards is the rms value of the magnitude error within each slot.

Differentiator 490 is a device for finding the gradient of phase error signal θ at each of multiple intervals shorter than the slot length. The gradient of phase error signal θ with respect to the axis in the direction of time represents the frequency error of signal under test S. Multiple intervals are lined up in a time series, adjacent to one another or partially overlapping one another. Moreover, the overall length when multiple intervals are regarded as one interval is longer than one slot. When multiple intervals are lined up adjacent to one another in a time series, for instance, the first interval is regarded as chip 0 through chip 127, the second interval is regarded as chip 128 through chip 255, and so forth, up to the last interval of chip 4,864 through chip 5,119. In addition, when multiple intervals are lined up in a time series partially overlapping one another, for instance, the first interval is regarded as chip 0 through chip 127, the second interval is regarded as chip 64 through chip 191, the third interval is regarded as chip 128 through chip 255, and so forth, up to the last interval of chip 4,864 through chip 5,119. The length of each interval is exactly the same in the above-mentioned examples, but this is not necessarily the case. For instance, it is possible to make the interval length longer in places where the slope of the gradient of phase error signals θ is gentle and the interval length shorter in places where the change in the gradient of phase error signals θ is steep. The extent to which each interval overlaps can be designed separately for each individual interval. The gradient of phase error signals θ in each interval is calculated as gradient f of the approximation line with regard to the phase error signals θ within each interval. Gradient f of the approximation line in one interval can be found by the following formula using the least squares method. x₁ is the time at each measurement point, yᵢ is the value of phase error signal θ at each measurement point, and n is the number of measurement points.

[Mathematical formula 2]

$$f = \frac{{\sum }_{i = 1}^{n} {x}_{i} {\sum }_{i = 1}^{n} {y}_{i} - n {\sum }_{i = 1}^{n} {x}_{i} {y}_{i}}{{\sum }_{i = 1}^{n} {x}_{i} {\sum }_{i = 1}^{n} {x}_{i} - n {\sum }_{i = 1}^{n} {x}_{i}^{2}} \qquad ( 2 )$$

A differentiator 491 is the device for finding the gradient of phase error signals θ at each slot. The gradient of phase error signals θ at each slot is calculated as gradient f of the approximation line with regard to phase error signals θ within each slot. Gradient f of the approximately line at each slot can be found by the above-mentioned formula using the least squares method. It should be noted that the gradient of phase error signals θ is the average frequency error specified by 3GPP standards, and the like.

Finally, by controlling display 500, computer 400 displays, in the form of a graph, gradient f of phase error signals θ at each interval as frequency error such that the corresponding intervals are lined up in a time series. Moreover, there are cases in which the changes in the phase direction of signals to be measured S can be more easily recognized by monitoring frequency error and there are cases where such changes can be more easily recognized by being monitored as phase error. Therefore, in addition to the graph of frequency error f, phase error signal θ is displayed as a graph on the display screen of display 500. Furthermore, by controlling display 500, computer 400 displays the graph of frequency error f, as well as a graph of modulation accuracy (EVM in the case of W-CDMA) on the display screen of display 500. The time positions of the graphs of frequency error f, phase error signals θ, and modulation accuracy are all the same. Moreover, graphs of frequency error f, phase error signals θ, and modulation accuracy are continuous at the front and back of the slot boundary. Specific examples of the display screen of display 500 are described below. A line showing the boundary of the slots is drawn on the display screen of display 500 such that it overlaps the above-mentioned graph or it is parallel with the graph in question,

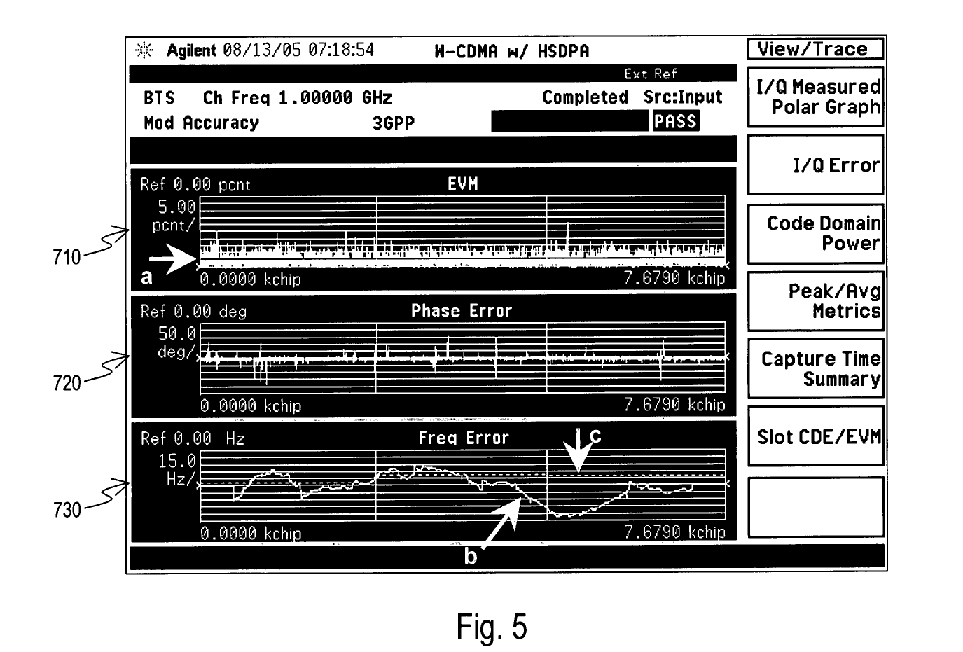

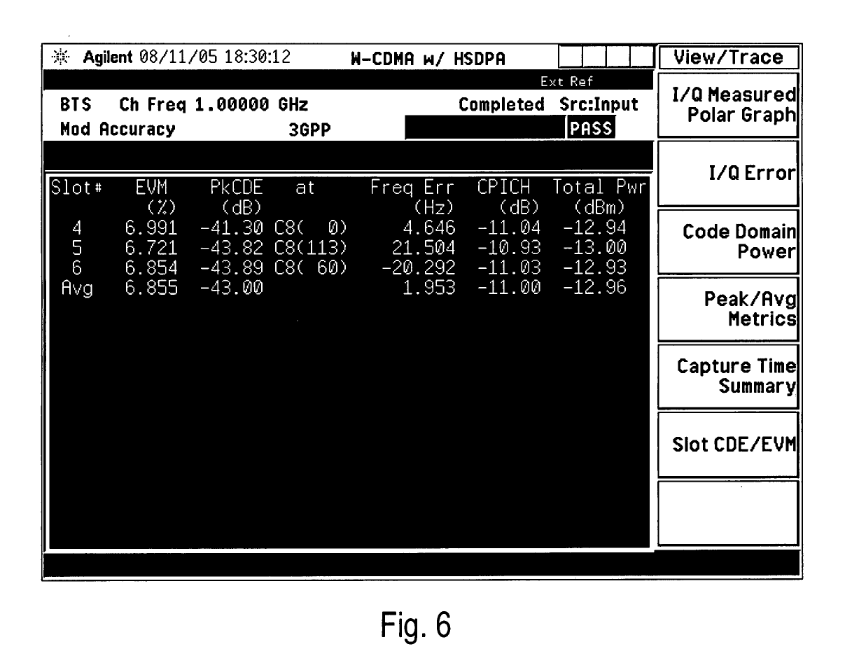

Refer to FIGS. 5 and 6 below. FIG. 5 shows the screen dump image of a display screen that graphically displays modulation accuracy (composite EVM), phase error θ, and frequency error f of signals under test S, which are W-CDMA signals. The modulation accuracy (composite EVM), phase error θ, and frequency difference f are represented as the value of each chip. Moreover, FIG. 6 shows the screen dump image of a display screen that shows the modulation accuracy (composite EVM) and average frequency error (Freq Err) in table form. FIGS. 5 and 6 show the results of measuring the same signals. FIG. 5 shows, in order from the top, a window 710 that displays modulation accuracy (composite EVM) as a graph; a window 720 that displays phase error θ as a graph, and a window 730 that displays frequency error f as a graph. The x-axis of the graphs in each window is 720 is degrees. The y-axis in window 730 is Hz (Hertz). Moreover, the corners in each graph point to zero. The dark line shown by arrow a is the horizontal line showing the rms of the composite EVM in each slot, and is constant within a slot. The graph which is broken line shown by arrow b in window 730 represents frequency error f. Moreover, the graph which is dotted line shown by arrow c in window 730 represents the average frequency error of signals under test S. The graph shown by arrow c is the horizontal line that shows the average frequency error of each slot, and is constant within a slot. The x-axis uses the same scale as described above in FIG. 5 such that it is possible to see the correlation between each graph in chip units. Moreover, the time positions (chip positions) of the graphs of frequency error f, phase error signals θ, and modulation accuracy (composite EVM) are all the same.

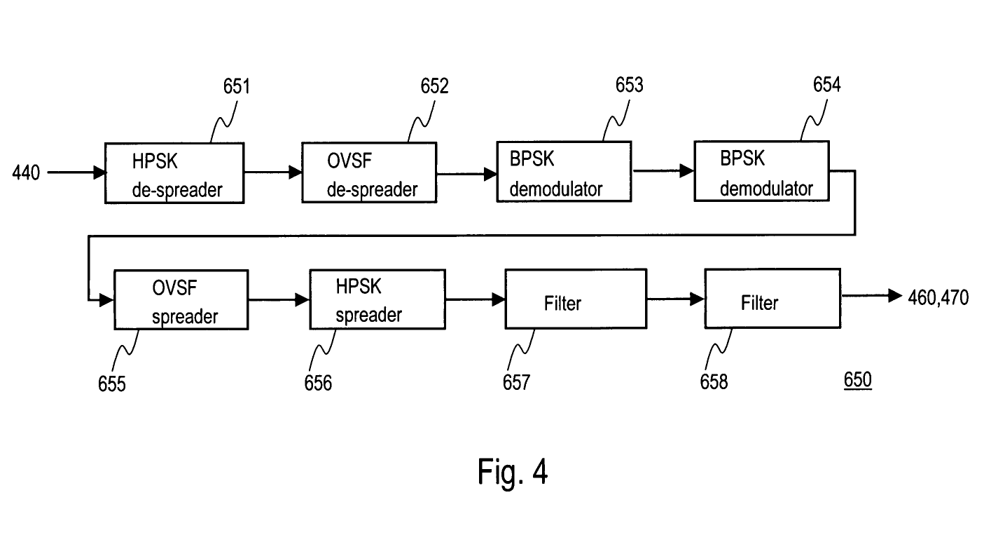

In the each of the above-mentioned embodiments, reference signal generator 450 generates the reference signals needed to measure the frequency error of the downlink signals. Reference signal generator 450 can be replaced by a reference signal generator 650 when measuring the frequency error of uplink signals. Refer to FIG. 4. FIG. 4 is a drawing showing the internal structure of reference signal generator 650. Reference signal generator 650 comprises an HPSK de-spreader 651, an OVSF de-spreader 652, a digital demodulator 653, a digital modulator 654, an OVSF de-spreader 655, an HPSK spreader 656, a filter 657, and a filter 658. In-phase base band signals I₃ and quadarature base band signal Q₃ are subjected to de-spreading by HPSK de-spreader 651, then the active channels are subjected to de-spreading by OVSF de-spreader 652, and the channels are further subjected to BPSK demodulation by digital demodulator 653. Bit data are thereby replicated. These bit data are remodulated and respread using the modulation parameters and spreading parameters that were used to generate signals under test S. That is, the replicated bit data are subjected to BPSK modulation by digital modulator 654, then the data are subjected to spreading by OVSF spreader 655, and the results are further subjected to spreading by HPSK spreader 656. The results of HPSK spreading are filter processed by filters 657 and 658, and the filtering results are output as in-phase reference signals I_{R1} and quadarature reference signals Q_{R1}. Filters 657 and 658 are root Nyquist filters stipulated in 3GPP standards.

Moreover, frequency converter 100 can be eliminated from the above-mentioned embodiments. In this case, computer 400 functions as the same down converter as frequency converter 100 through the execution of a program.

The above-mentioned embodiments have described a W-CDMA system, but the present disclosure can be similarly applied to a CDMA system whereby data are transmitted and received in slot units, including the pilot signals for each slot, or a CDMA system whereby data are transmitted and received in slot units using common pilot signals, that is a CDMA system other than a W-CDMA system. As in the above-mentioned embodiments, it is possible to detect the phase difference signals which represent the phase difference at the symbol evaluation points between the receiver filter-processed signals under test and the reference signals obtained by remodulation and respreading of bit data replicated by de-spreading and demodulation of the filter-processed signals under test, or to calculate the signals obtained by differentiation of the phase difference signals in question, and graphically display either of the signals over the period of time when they have a length exceeding one slot. For instance, when the frequency error of a CDMA 2000 system is measured, the basic structure of the measuring apparatus is the same as with measuring apparatus 10, but it differs in that an M series code or a Walsh code is used in place of the OVSF code. Moreover, the appropriate parameters in accordance with each CDMA system are used for the modulation accuracy graphically represented together with frequency difference f. For instance, the composite EVM of each chip is graphically represented together with frequency error f in the case of the CDMA 2000 system.

What is claimed is:

1. An apparatus for measuring the frequency error of digital modulation signals from a CDMA system whereby data are transmitted and received in slot units, including the pilot signals for each slot, or a CDMA system whereby data are transmitted and received in slot units using common pilot signals, said apparatus comprising:
a reference signal generator for remodulation and respreading of bit data obtained by de-spreading and demodulation of said digital modulation signals using the modulation parameters and spreading parameters that are used when said digital modulation signals are generated, and outputting the resulting signals as reference signals;
a comparator for comparing said digital modulation signals and said reference signals and generating phase error signals that represent the phase error at each symbol evaluation point of the digital modulation signals with respect to said reference signals; and
a differentiator for calculating the gradient of said phase error signals for each of multiple intervals shorter than the slot length of said digital modulation signals,
wherein each of the multiple intervals is lined up in a time series adjacent to one another or partially overlapping one another and the overall length is longer than one slot.

2. The apparatus for measuring the frequency error according to claim 1, further comprising an display device for displaying a graph of the calculation results of said differentiator lined up in a time series.

3. The apparatus for measuring the frequency error according to claim 2, wherein said display device displays a graph of the modulation accuracy of said digital modulation signals such that its time position coincides with the graph of said calculation results.

4. The apparatus for measuring the frequency error according to claim 2, wherein said display device displays a graph of the phase error signals such that its time position coincides with the graph of said calculation results.

5. An apparatus for measuring the phase error of digital modulation signals from a CDMA system whereby data are transmitted and received in slot units, including the pilot signals for each slot, or a CDMA system whereby data are transmitted and received in slot units using common pilot signals, said apparatus comprising:
a reference signal generator for remodulation and respreading of bit data obtained by de-spreading and demodulation of said digital modulation signals using the modulation parameters and spreading parameters that are used when said digital modulation signals are generated, and outputting the resulting signals as reference signals; and
a comparator for comparing said digital modulation signals and said reference signals and generating phase error signals that represent the phase error at each symbol evaluation point of the digital modulation signals with respect to said reference signals.

6. The apparatus for measuring phase error according to claim 5, further comprising an display device for displaying a graph of said phase error signals.

7. The apparatus for measuring phase error according to claim 6, wherein said graph of said phase error signals is continuous at the front and back of the boundary of each slot.

8. The apparatus for measuring phase error according to claim 6, wherein said display device displays a graph of the phase error signals such that the [its?] time position coincides with said graph of said phase error signals.

9. A method for measuring the frequency error of digital modulation signals from a CDMA system whereby data are transmitted and received in slot units, including the pilot signals for each slot, or a CDMA system whereby data are transmitted and received in slot units using common pilot signals, said method comprising:
remodulating and respreading of bit data obtained by de-spreading and demodulation of said digital modulation signals using the modulation parameters and spreading parameters that are used when said digital modulation signals are generated, and outputting the resulting signals as reference signals;
comparing said digital modulation signals and said reference signals and generating phase error signals that represent the phase error at each symbol evaluation point of the digital modulation signals with respect to said reference signals; and
calculating the gradient of said phase error signals for each of multiple intervals shorter than the slot length of said digital modulation signals,
outputting the calculation results,
wherein each of the multiple intervals are lined up in a time series adjacent to one another or partially overlapping one another and the overall length is longer than one slot.

10. The method according to claim 9, further comprising displaying a graph of the calculation results lined up in a time series.

11. The method according to claim 10, further comprising displaying a graph of the modulation accuracy of said digital modulation signals such that its time position coincides with the graph of said calculation results.

12. The method according to claim 10, further comprising displaying a graph of the phase error signals such that its time position coincides with the graph of the calculation results.

13. A method for measuring the phase error of digital modulation signals from a CDMA system whereby data are transmitted and received in slot units, including the pilot signals for each slot, or a CDMA system whereby data are transmitted and received in slot units using common pilot signals, said method comprising:
remodulating and respreading of bit data obtained by de-spreading and demodulation of said digital modulation signals using the modulation parameters and spreading parameters that are used when said digital modulation signals are generated, and outputting the resulting signals as reference signals; and
comparing said digital modulation signals and said reference signals and generating phase error signals that represent the phase error at each symbol evaluation point of the digital modulation signals with respect to said reference signals;
thereby measuring the phase error of said digital modulation signals.

14. The method according to claim 13, further comprising displaying a graph of said phase error signals.

15. The method according to claim 14, wherein said graph of said phase error signals is continuous at the front and back of the boundary of each slot.

16. The method according to claim 14, further comprising displaying a graph of the phase error signals such that the time position coincides with the graph of the calculation results.
